(19) United States
(12) Patent Application Publication
(10) Pub. No.: US 2014/0181161 A1
(43) Pub. Date: Jun. 26, 2014

(54) METHOD AND SYSTEM FOR SPEEDING UP COMPUTER PROGRAM

(71) Applicant: Tencent Technology (Shenzhen) Company Limited, Shenzhen (CN)

(72) Inventors: Tiange Si, Shenzhen (CN); Chao Bian, Shenzhen (CN); Jinzhou Jiang, Shenzhen (CN)

(73) Assignee: Tencent Technology (Shenzhen) Company Limited, Shenzhen (CN)

(21) Appl. No.: 14/195,210

(22) Filed: Mar. 3, 2014

Related U.S. Application Data
(63) Continuation of application No. PCT/CN2013/073196, filed on Mar. 26, 2013.

(30) Foreign Application Priority Data
Apr. 25, 2012 (CN) 201210123796.0

(51) Int. Cl. G06F 17/30

(52) U.S. Cl. CPC G06F 17/30221; G06F 17/30091
USPC 707/823; 707/822

(57) ABSTRACT

A method and system for speeding up a computer program is provided. The method includes: determining a critical file and a non-critical file; storing the non-critical file in a first storage device, and storing the critical file in a second storage device, wherein data accessing speed of the second storage device is faster than that of the first storage device; and receiving a file operation for accessing the critical file, redirecting the file operation to the second storage device, accessing the critical file stored in the second storage device. As for the characteristic that the speed for reading and writing the file is limited by the speed of the storage device, the file operation for accessing the critical file is redirected to the file stored in the device with faster speed via the redirection technology, to speed up the startup and running speed of the program.

### CROSS-REFERENCES TO RELATED APPLICATIONS

This application is a continuation of International application PCT/CN2013/073196, filed on Mar. 26, 2013 which claims the benefit of priority from Chinese Patent Application, No. 201210123796.0, entitled “Method and System for Speeding up a Computer Program” and filed on Apr. 25, 2012, the entire contents of which are hereby incorporated by reference.

### TECHNICAL FIELD

The present disclosure relates to a computer software technology field, more particularly, to a method and system for speeding up a computer program.

### BACKGROUND

A computer program or software program (typical called a program) refers to a group of instructions instructing each operation of a computer. The program is typically programmed with a programming language, and runs on target architecture. Generally speaking, the program is an aggregation of commands programed with a computer language for achieving a specific target or solving a specific problem.

In order to run a program, an Operating System (OS) first loads the program, and then executes the program. In the case that processing ability of the computer is determined, operation efficiency of the software depends on two factors, i.e., resources and time needed for loading and accessing the program, and time needed for running the program. Therefore, in order to optimize the operation efficiency of the program, the above two factors affecting the operation efficiency of the software need to be adjusted.

In the computer, codes and resources in a file are saved in a low speed device, such as a disk. Therefore, the method for reducing the time for loading the codes and accessing the resources is that for reducing time for accessing a relevant file, such as the program. In the conventional method, the method typically used for reducing the time for accessing the file is pre-loading the file. Therefore, if the system needs to read the codes and resources, the system directly reads these codes and resources from a cache of the system, which may avoid performance loss for reading fragmented files.

However, the pre-loading still needs to access the disk, while accessing speed of a device, such as the disk is very slow.

Before running the pre-loaded program, resources needed to be loaded cannot be speeded up.

During the running of the software, a writing operation made on a file, such as needed resources, causes the performance loss.

In summary, in the conventional method, since the low speed device, such as the disk needs to be accessed, the startup and running speed of the program is low.

### SUMMARY

An embodiment of the present disclosure provides a method for speeding up a computer program, to speed up the program.

Another embodiment of the present disclosure provides a system for speeding up a computer program, to speed up the program.

The specific scheme of the embodiments of the present disclosure is as follows.

A method for speeding up a computer program includes:

determining a critical file and a non-critical file;

storing the non-critical file in a first storage device, and storing the critical file in a second storage device, wherein data accessing speed of the second storage device is faster than that of the first storage device; and

receiving a file operation for accessing the critical file, redirecting the file operation to the second storage device, accessing the critical file stored in the second storage device.

A system for speeding up a computer program includes:

a data file classifying unit, configured to determine a critical file and a non-critical file;

a first storage device, configured to store the non-critical file;

a second storage device, configured to store the critical file;

a redirection unit, configured to receive a file operation for accessing the critical file, redirect the file operation to the second storage device and access the critical file in the second storage device; wherein

data accessing speed of the second storage device is faster than that of the first storage device.

It can be seen from the above technical scheme that in embodiments of the present disclosure, the critical file and the non-critical file are determined according to factors affecting the speed-up of the computer program. The non-critical file is stored in the first storage device, and the critical file is stored in the second storage device. The data accessing speed of the second storage device is faster than that of the first storage device. The method for speeding up the computer program includes: receiving the file operation for accessing the critical file, redirecting the file operation to the second storage device, and accessing the critical file stored in the second storage device. On the basis of the above analysis, in the embodiments of the present disclosure, as for the characteristic that the speed for reading and writing the file is limited by the speed of the storage device, the file operation for accessing the critical file is redirected to the file stored in the device with faster speed via the redirection technology, to speed up the startup and running speed of the program.

Furthermore, in the embodiments of the present disclosure, the speed-up efficiency and speed-up cost of the program may be considered by classifying the data files into the critical file and the non-critical file.

### BRIEF DESCRIPTION OF DRAWINGS

FIG. 1 is a flow chart illustrating a method for speeding up a computer program in accordance with an embodiment of the present disclosure;

FIG. 2 is a flow chart illustrating a method for speeding up a computer program in accordance with a first embodiment of the present disclosure;

FIG. 3 is a flow chart illustrating a method for speeding up a computer program in accordance with a second embodiment of the present disclosure; and

FIG. 4 is a schematic diagram illustrating structure of a system for speeding up a computer program in according with an embodiment of the present disclosure.

### DETAILED DESCRIPTION

To make the above and other features and merits of the present disclosure more apparent, the illustrative embodiments of the present disclosure are described hereafter in detail with reference to the accompanying drawings.

On basis of the above analysis, in the computer, the codes and resources are saved in the file. If dependence on the low speed storage device cannot be avoided or reduced, it is difficult to speed up the program. In the present application, the speeding-up of the program includes speeding up startup speed and running speed of the program. In the conventional method, if the program needs to access a file, the program directly access the file on the disk, while the reading and writing speed of the file is limited by the running speed of the disk.

In embodiments of the present disclosure, in order to speed up the startup and running speed of the program, a redirection technology is adopted to redirect reading and writing operations on these files, i.e., the files stored in a low speed storage device, such as a disk, to the same files stored in a storage device with faster reading and writing speed (especially with faster random reading and writing speed), to speed up the startup and running speed of the program.

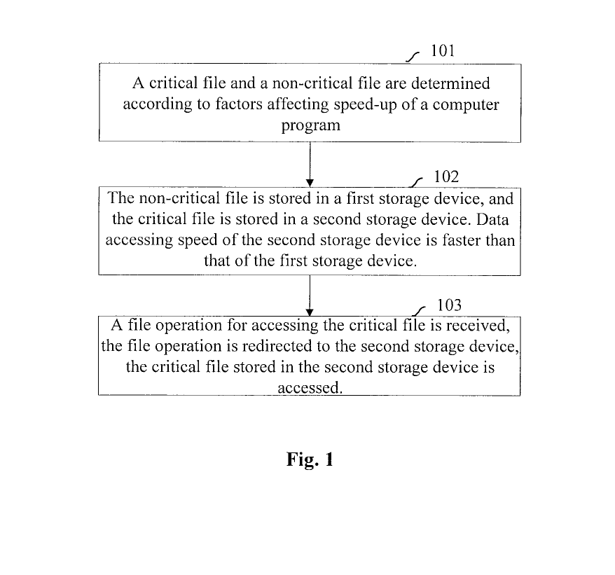

FIG. 1 is a flow charting illustrating a method for speeding up a computer program in accordance with an embodiment of the present disclosure.

As shown in FIG. 1, the method includes following blocks.

In block 101, a critical file and a non-critical file are determined.

The critical file and the non-critical file are determined according to factors affects the speeding-up of the computer program. Only the currently accessed file is determined as the file which needs to be speeded up (i.e., the critical file), the redirection operation is performed subsequently; otherwise, the redirection operation needs not to be performed.

No matter the critical file or the non-critical file is accessed, the accessing process needs resources. Furthermore, in the accessing process, the program starts and runs. In addition, on the basis of different application scenes and speeding-up functions, the method for determining the critical file and the non-critical file does not follow a consistent pattern, and may be changed.

For instance, in the startup process of the program, a startup UI and a user configuration file have a great impact on the startup speed of the program. Therefore, the startup UI and user configuration file are determined as the critical files. While in the running process of the program after the startup process, the startup UI has a little impact on the running of the program. Therefore, at this moment, the startup UI may be determined as the non-critical file.

In embodiments of the present disclosure, the file which must be accessed in the startup process and running process of the computer program is defined as the critical file, and the file which may be accessed or may not be accessed in the startup process and running process of the computer program is defined as the non-critical file. Embodiments of the present disclosure merely provide an example for defining the critical file and the non-critical file. The method for defining the critical path and the non-critical path in the technical scheme of the present disclosure is not limited to this example. In practice, the critical file and the non-critical path may be defined according to actual needs.

In block 102, the non-critical file is stored in a first storage device, and the critical file is stored in a second storage device. Data accessing speed of the second storage device is faster than that of the first storage device.

The first storage device includes at least one of a hard disk, a tape and a floppy disk. The second storage device at least includes one of a RAM disk, a Solid State Drive or an IDE FLASH DISK.

The RAM disk is a virtual local disk of partial areas in the memory of the computer. The Solid State Drive consists of a control unit and a storage unit (a FLASH chip). The Solid State Drive is a hard disk made by a state electronic storage chip array. The data accessing speed of the Solid State Drive is faster than that of the ordinary hard disk. Preferably, the critical file may be further saved in the first storage device.

In block 103, a file operation for accessing the critical file is received, the file operation is redirected to the second storage device, and the critical file in the second storage device is accessed.

The file operation of the critical file includes a reading request and a writing request.

The following description takes the reading request for example.

In an embodiment, the reading request for accessing the critical file is received first, then the reading request of the critical file is redirected to the second storage device, and the critical file is read from the second storage device.

As for the reading operation, typically, only the simple redirection request is needed, the critical file can be correctly read from the second storage device. As for the writing operation, complicated mechanism is needed to ensure that the correct file is read. The reason is that if the high speed device cannot permanently store the written data (such as, the data stored in the memory will loss if the computer is restarted), a data write-back operation is needed. Therefore, a write-back module is needed while the redirection is performed. When the writing operation is completed, the write-back module is informed that the critical file is modified, and modified contents need to be written into the original file.

Specifically, as for the writing operation, the writing request of the critical file is redirected to the second storage device, data is written into the critical file in the second storage device, and the written data is written back to the first storage device.

The write-back operation is performed in the following circumstances:

First: when the file, into which the data is written, is read;

Second: when a redirection function is uninstalled;

Third: when the computer shuts down; and

Fourth: when the writing operation is completed.

In the above fourth circumstance, when the writing operation is completed, an asynchronous write-back operation is performed. The circumstances in which the write-back operation is performed are listed above. It is well known to an ordinary skilled in the art that the above circumstances are illustrative, and are not used for limiting the protection scope of the embodiments of the present disclosure.

How the redirection function is implemented is described hereafter.

In an embodiment, the file operation for accessing the critical file is received, a file request path in the file operation is modified as a file path of the second storage device, and the file operation is redirected to the second storage device.

Specifically, first, a file system filters a driver, and redirects the file operation in the core module. In a callback function of an IRP_MJ_CREATE, the file path requested in the IRP is modified as the redirected file path, an IOCompleteRequest interface is called, and the redirection of the file may be completed by processing the IRP.

As for the write-back operation, in the callback function of IRP_MJ_WRITE, or on the write interface of a FastIO, if the writing operation is detected, the write-back operation may be performed by calling a ZwWriteFile at appropriate time.

The advantages of the above method are that the complete redirection may be implemented. Since the service is provided in the kernel mode the problem that the codes are speeded up with themselves is avoided.

In another embodiment, a hook function may be set, and a file operation function is replaced with the hook function to redirect the file operation to the second storage device. Optionally, the program may initiatively detect whether a file which may be speeded up is stored in the second storage device. If the file which may be speed up is stored in the second storage device, the file in the second storage device is used.

Specifically, the file operation functions, such as NtCreateFile and LoadLibraryEx, may be modified with an ApiHook function. When these file operation functions are called, if the accessed file is the file needed to be redirected, a target file is opened, and the file needed to be redirected is opened with an original function.

There are limitations for implementing the redirection with the ApiHook method. Before the Hook function is initialized, the operation for redirecting the file cannot be performed, codes of the file cannot be redirected, and the operation for loading the speeded up codes cannot be completely achieved.

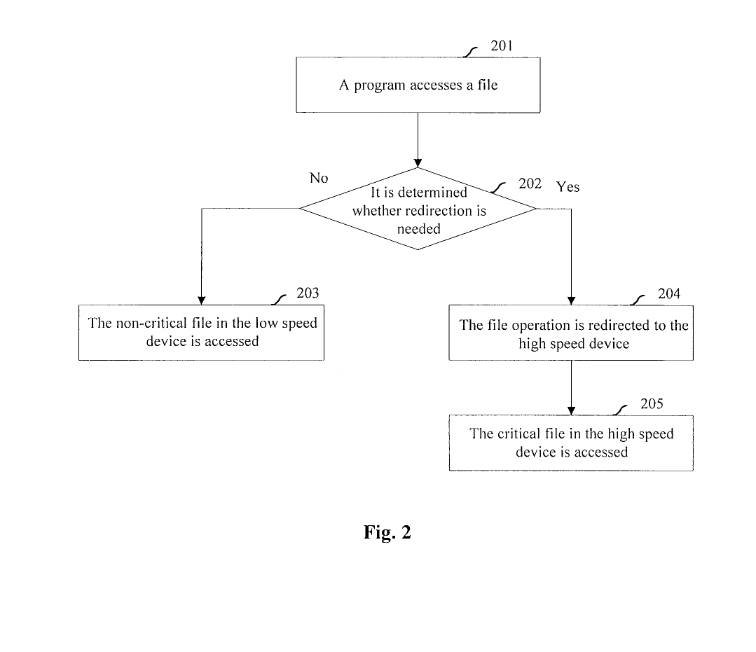

On the basis of the above analysis, FIG. 2 is a flow chart illustrating a method for speeding up a computer program in accordance with a first embodiment of the present disclosure. In the flow shown in FIG. 2, a low speed device stores a non-critical file, and a high speed device stores a critical file. Data accessing speed of the high speed device is faster than that of the low speed device.

As shown in FIG. 2, the method includes the following blocks.

In block 201, a program accesses a file.

In block 202, it is determined whether redirection needs to be performed. If yes, block 204 and subsequent blocks are performed; otherwise, block 203 is performed and this flow ends.

It is determined whether the to-be-accessed file is the critical file or the non-critical file according to factors affecting the speeding-up of the computer program. If the file is the non-critical file, it is determined that redirection need not to be executed. If the file is the critical file, it is determined that the redirection needs to be performed.

In block 203, the non-critical file in the low speed device is accessed, and the flow ends.

In block 204, the file operation is redirected to the high speed device.

In block 205, the critical file in the high speed device is accessed.

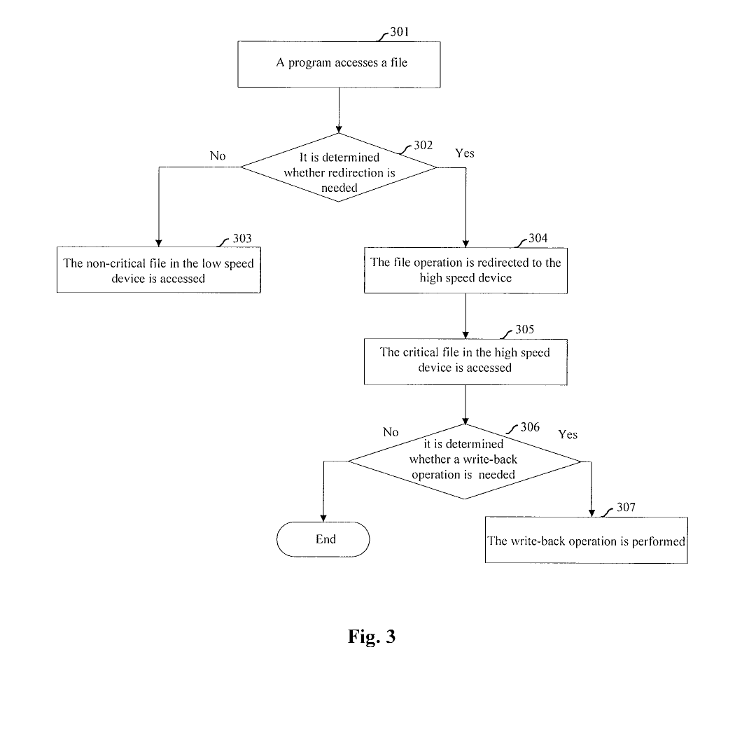

An embodiment of the present disclosure is described hereafter with specific operations. FIG. 3 is a flow chart illustrating a method for speeding up a computer program in accordance with a second embodiment of the present disclosure. In the flow shown in FIG. 3, a low speed device stores a non-critical file, and a high speed device stores a critical file. Data accessing speed of the high device is faster than that of the low speed device.

As shown in FIG. 3, the method includes the following blocks.

In block 301, a program accesses a file.

In block 302, it is determined whether redirection needs to be performed. If yes, block 304 and subsequent blocks thereof are performed; otherwise, block 303 is performed, the flow ends.

Whether the to-be-accessed file is the critical file or not is determined according to the factors affecting the speeding-up of the computer program. If the file is the non-critical file, the redirection needs not to be performed. If the file is the critical file, the redirection needs to be performed.

In block 303, the non-critical file in the low speed device is accessed, and the flow ends.

In block 304, a file operation is redirected to the high speed device.

In block 305, the critical file in the high speed device is accessed.

In block 306, it is determined whether a write-back operation needs to be performed. If yes, block 307 and subsequent blocks are performed; otherwise, the flow ends.

If the file operation for accessing the file is a writing operation, a data write-back operation needs to be performed.

In block 307, the write-back operation is performed.

The data is written into the critical file stored in the high speed device, and the written data is written back to the low speed device.

On the basis of the above analysis, an embodiment of the present disclosure further provides a system for speeding up a computer program.

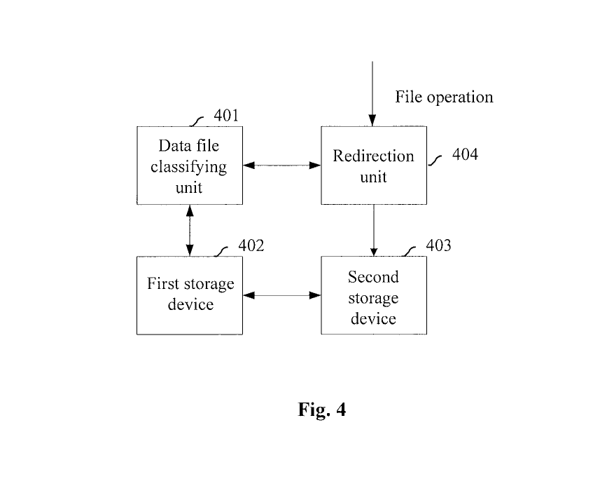

FIG. 4 is a schematic diagram illustrating structure of a system for speeding up a computer program in accordance with an embodiment of the present disclosure.

As shown in FIG. 4, the system includes: a data file classifying unit 401, a first storage device 402, a second storage device 403 and a redirection unit 404.

The data file classifying unit 401 is configured to determine a critical file and a non-critical file according to factors affecting speeding-up of the computer program.

The first storage device 402 is configured to store the non-critical file.

The second storage device 403 is configured to store the critical file. Data accessing speed of the second storage device is larger than that of the first storage device.

The redirection unit 404 is configured to receive a file operation for accessing the critical file, redirect the file operation to the second storage device, and access the critical file in the second storage device.

In an embodiment, the data file classifying unit 401 is configured to determine a startup UI and a user configuration file as the critical file according to the factors affecting the startup speed of the computer program.

In an embodiment, the first storage device 402 includes at least one of a hard disk, a tape or a floppy disk. The second storage device 403 at least includes one of a RAM disk, a Solid State Drive or an IDE FLASH DISK.

The redirection unit 404 is configured to receive a reading request for reading the critical file, redirect the reading request to the second storage device 403, and read the critical file from the second storage device 403.

The redirection unit 404 is configured to receive a writing request for writing the critical file, redirect the writing request to the second storage device 403, write the data in the critical file stored in the second stored device, and write the written data back to the first storage device 402.

The redirection unit 404 is configured to receive a file operation for accessing the critical file, modify a file request path in the file operation as a file path of the second storage device 403, and redirect the modified file operation to the second storage device 403.

The redirection unit 404 is configured to set a hook function, replace a file operation function with the hook function, and redirect the file operation to the second storage device 403.

Preferably, the redirection unit 404 is configured to write the written data back to the first storage device 402 when the file, into which the data is written is read, the redirection function is uninstalled, the computer shuts down or the writing operation is completed.

In can be seen from the above technical scheme that the critical file and the non-critical file are determined according to factors affecting the speed-up of the computer program. The non-critical file is stored in the first storage device, and the critical file is stored in the second storage device. The data accessing speed of the second storage device is faster than that of the first storage device. The method for speeding up the computer program includes: receiving the file operation for accessing the critical file, redirecting the file operation to the second storage device, and accessing the critical file stored in the second storage device. On the basis of the above analysis, in the embodiments of the present disclosure, as for the characteristic that the speed for reading and writing the file is limited by the speed of the storage device, the file operation for accessing the critical file is redirected to the file stored in the device with faster speed via the redirection technology, to speed up the startup and running speed of the program.

Furthermore, in the embodiments of the present disclosure, the speed-up efficiency and speed-up cost of the program may be considered by classifying the data files into the critical file and the non-critical file.

The foregoing are only embodiments of the present disclosure. The protection scope of the present disclosure, however, is not limited to the above description. Any change or substitution, easily occurring to those skilled in the art, should be covered by the protection scope of the present disclosure.

1. A method for speeding up a computer program, the computer program executed in a computer comprising a first storage device and a second storage device, the method comprising:
determining a critical file and a non-critical file, wherein the critical file is a file being accessed by the computer program;
storing the non-critical file in the first storage device, and storing the critical file in the second storage device, wherein data accessing speed of the second storage device is faster than that of the first storage device; and
receiving a file operation for accessing the critical file, redirecting the file operation to the second storage device, accessing the critical file stored in the second storage device.

2. The method according to claim 1, wherein storing the non-critical file in the first storage device comprises storing the non-critical file in one of a hard disk, a tape or a floppy disk; and
storing the critical file in the second storage device comprises storing the non-critical file in one of a RAM disk or a Solid State Drive.

3. The method according to claim 1, wherein in response to determining that the received file operation is a read request for reading the critical file, the method comprises
redirecting the reading request to the second storage device, and reading the critical file stored in the second storage device.

4. The method according to claim 1, wherein in response to determining that the received file operation is a writing request for writing the critical file, the method comprises:
redirecting the writing request to the second storage device, and writing data in the critical file stored in the second storage device; and
writing the data back to the first storage device.

5. The method according to claim 4, wherein writing the data back to the first storage device comprises:
writing the data back to the first storage device when a file, into which the data is written, is read, a redirection function is uninstalled, a computer shuts down or when a writing operation is finished.

6. The method according to claim 1, wherein determining the critical file and the non-critical file comprises:
determining a startup UI and a user configuration file as the critical file based on factors affecting startup speed of the computer program.

7. The method according to claim 1, wherein receiving the file operation for accessing the critical file, redirecting the file operation to the second storage device comprises:
receiving the file operation for accessing the critical file, modifying a file request path in the file operation as a file path of the second storage device; and
redirecting the modified file operation to the second storage device.

8. The method according to claim 7, wherein the file operation is a create request and the modified file operation is a modified create request;
redirecting the modified file operation to the second storage device comprises:
calling an IOCompleteRequest interface, and redirecting the modified create request to the second storage device.

9. The method according to claim 4, wherein writing the data back to the first storage device comprises:
in a callback function of an IRP_MJ_CREATE or on a Write interface of a FastIO, receiving the writing request for writing the data in the critical file, calling a ZwWriteFile function to write the data back to the first storage device.

10. The method according to claim I, wherein redirecting the file operation to the second storage device comprises:
setting a hook function, replacing a file operation function with the hook function, and redirecting the file operation to the second storage device.

11. A computer system for speeding up a computer program, the computer program executed in the computer system, the computer system comprising:
a data file classifying unit, configured to determine a critical file and a non-critical file, wherein the critical file is a file being accessed by the computer program;
a first storage device, configured to store the non-critical file;
a second storage device, configured to store the critical file;
a redirection unit, configured to receive a file operation for accessing the critical file, redirect the file operation to the second storage device and access the critical file in the second storage device;
wherein data accessing speed of the second storage device is faster than that of the first storage device.

12. The system according to claim 11, wherein the first storage device comprises at least one of a hard disk, a tape and a floppy disk; and
the second storage device comprises at least one of a RAM disk, a Solid State Drive, and an IDE FLASH DISK.

13. The system according to claim 11, wherein in response to a case that the redirection unit receives a reading request for reading the critical file, the redirection unit is configured to redirect the reading request to the second storage device and read the critical file stored in the second storage device.

14. The system according to claim 11, wherein in response to a case that the redirection unit receives a writing request for writing data in the critical file, the redirection unit is configured to redirect the writing request to the second storage device, write the data in the critical file stored in the second storage device and write the data back to the first storage device.

15. The system according to claim 14, wherein the redirection unit is further configured to write the data back to the first storage device when a file, into which the data is written, is read, a redirection function is uninstalled, a computer shuts down or when a writing operation is completed.

16. The system according to claim 11, wherein the data file classifying unit is further configured to determine a startup UI and a user configuration file based on factors affecting startup speed of the computer program as the critical file.

17. The system according to claim 11, wherein the redirection unit is configured to receive the file operation for accessing the critical file, modify a file request path in the file operation as a file path of the second storage device; and redirect the modified file operation to the second storage device.

18. The system according to claim 11, wherein the redirection unit is further configured to set a hook function, replace a file operation function with the hook function and redirect the file operation to the second storage device.

19. A non-transitory computer-readable medium storing a program, wherein execution of the program is for:
determining a critical file and a non-critical file;
storing the non-critical file in a first storage device, and storing the critical file in a second storage device, wherein data accessing speed of the second storage device is faster than that of the first storage device; and
receiving a file operation for accessing the critical file, redirecting the file operation to the second storage device, accessing the critical file stored in the second storage device.

20. The non-transitory computer-readable medium storing the program according to claim 19, wherein receiving the file operation for accessing the critical file comprises:
receiving a reading request for reading the critical file; and
redirecting the file operation to the second storage device, accessing the critical file stored in the second storage device comprises:
redirecting the reading request to the second storage device,
and reading the critical file stored in the second storage device,
or, receiving the file operation for accessing the critical file comprises:
receiving a writing request for writing data in the critical file; and
redirecting the file operation to the second storage device, and accessing the critical file stored in the second storage device comprises:
redirecting the writing request to the second storage device, and writing the data in the critical file stored in the second storage device, wherein the method further comprises:
writing the data back to the first storage device.
